(19) United States
(12) Patent Application Publication
(10) Pub. No.: US 2015/0185466 A1
(43) Pub. Date: Jul. 2, 2015

(54) SHUTTER-BASED LIGHT MODULATORS INCORPORATING TIERED BACKPLANE SLOT STRUCTURES

(71) Applicant: Pixtronix, Inc., San Diego, CA (US)

(72) Inventors: Xiang-Dong MI, Northborough, MA (US); Jianru SHI, Haverhill, MA (US); Jignesh GANDHI, Burlington, MA (US)

(73) Assignee: Pixtronix, Inc., San Diego, CA (US)

(21) Appl. No.: 14/254,516

(22) Filed: Apr. 16, 2014

Related U.S. Application Data
(60) Provisional application No. 61/923,026, filed on Jan. 2, 2014.

(51) Int. Cl. G02B 26/02; G06F 3/01; G06T 1/20

(52) U.S. Cl. CPC G02B 26/02; G06T 1/20; G06F 3/01

(57) ABSTRACT

This disclosure provides systems, methods and apparatus for a MEMS display apparatus incorporating a tiered backplane slot structure. The backplane can include two or more light-blocking layers defining optical windows and positioned at different heights. Light can pass through the optical windows of the display apparatus at an angle. In some implementations, the angle can be based on the index of refraction of a transparent material inside the display apparatus. The transmission of off-axis and on-axis light can be improved by varying the widths of the optical windows in each layer of the backplane. In some implementations, the difference in the widths of optical windows of adjacent layers can be substantially equal to the separation distance between the layers.

### CROSS-REFERENCE TO RELATED APPLICATIONS

This patent application claims priority to U.S. Provisional Patent Application No. 61/923,026, filed on Jan. 2, 2014, entitled “Shutter-Based Light Modulators Incorporating Tiered Backplane Slot Structures.” The disclosure of the prior application is considered part of and is incorporated by reference in this patent application.

### TECHNICAL FIELD

This disclosure relates to the field of displays, and in particular, electromechanical systems (EMS) display elements.

### DESCRIPTION OF THE RELATED TECHNOLOGY

Electromechanical systems (EMS) devices include devices having electrical and mechanical elements, such as actuators, optical components (such as mirrors, shutters, and/or optical film layers) and electronics. EMS devices can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of deposited material layers, or that add layers to form electrical and electromechanical devices.

EMS-based display apparatus have been proposed that include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus. The apparatus includes a substrate and a display element. The display element includes a backplane suspended over the substrate. The backplane includes a first light-blocking layer oriented parallel to the substrate and defining a first optical window having a first width. The backplane includes a second light blocking layer oriented parallel to the substrate and spaced above the first light-blocking layer by a first height. The second light blocking layer defines a second optical window having a second width, greater than the first width.

In some implementations, the second width is equal to the first width plus between about 1.6 to about 2.4 times the first height. In some implementations, the backplane also includes a first dielectric layer positioned between the first light blocking layer and the second light-blocking layer. In some implementations, the backplane includes a third light-blocking layer oriented parallel to the substrate and spaced above the second light-blocking layer by a second height. The third light blocking layer can define a third optical window having a third width, greater than the second width. In some implementations, the third width can be equal to the second width plus between about 1.6 to about 2.4 times the second height.

In some implementations, the apparatus can include a transparent fluid filling the space between the substrate and the backplane. In some implementations, the relationship between the first width and the second width is based in part on the first height and an index of refraction of the transparent fluid. In some implementations, the third light-blocking layer has a lower reflectivity than the first light blocking layer and the second light blocking layer. In some implementations, the backplane also can include a second dielectric layer positioned between the second light-blocking layer and the third light-blocking layer. The second dielectric layer can include a material having a higher index of refraction than the first dielectric layer. In some implementations, the second dielectric layer can be etched away in the third optical window.

In some implementations, the apparatus can include a display, a processor and a memory device. The processor can be configured to communicate with the display and process image data. The memory device can be configured to communicate with the processor. In some implementations, the apparatus can also include a driver circuit and a controller. The driver circuit can be configured to send at least one signal to the display. The controller can be configured to send at least a portion of the image data to the driver circuit. In some implementations, the apparatus includes an image source module that can be configured to send the image data to the processor. The image source module can include at least one of a receiver, transceiver, and transmitter. In some implementations, the apparatus can include an input device. The input device can be configured to receive input data and to communicate the input data to the processor.

Another innovative aspect of the subject matter described in this disclosure can be implemented in a method of manufacturing a display apparatus. The method includes fabricating a display backplane and fabricating a plurality of display elements over and in electrical communication with the backplane. Fabricating the display backplane includes depositing a first layer of light blocking material over a substrate and defining a first set of optical windows through the first layer of light blocking material. Each optical window has a first width. Fabricating the display backplane further includes depositing a second layer of light blocking material over the first layer of light blocking material and spaced above the first layer of light blocking material by a first height and defining a second set of optical windows through the second layer of light blocking material. Each optical window in the second set of optical windows is substantially aligned with a corresponding optical window in the first set of optical windows and has a second width, smaller than the first width. In some implementations, the first width is in the range of about the second width plus between about 1.6 and about 2.4 times the first height.

In some implementations, the method also includes depositing a third layer of light blocking material over the second layer of light blocking material and spaced above the second layer of light blocking layer by a second height, and defining a third set of optical windows through the third layer of light blocking material. Each optical window in the third set of optical windows can be substantially aligned with respective optical windows in the first and second sets of optical windows and can have a third width smaller than the first and second widths. In some implementations, the second width is in the range of about the third width plus between about 1.6 and about 2.4 times the second height.

In some implementations, the method includes depositing a first dielectric layer over the first layer of light blocking material prior to depositing the second layer of light blocking material, and depositing a second dielectric layer over the second layer of light blocking material prior to depositing the third layer of light blocking material. In some implementations, the second dielectric layer includes a material having a higher index of refraction than that of the material in the first dielectric layer.

Details of one or more implementations of the subject matter described in this specification are set forth in the accompanying drawings and the description below. Although the examples provided in this summary are primarily described in terms of MEMS-based displays, the concepts provided herein may apply to other types of displays, such as liquid crystal displays (LCDs), organic light emitting diode (OLED) displays, electrophoretic displays, and field emission displays, as well as to other non-display MEMS devices, such as MEMS microphones, sensors, and optical switches. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows a cross-sectional view of an example shutter-based display apparatus including a tiered backplane slot structure.

FIG. 4A shows a top view of the M3 layer of the backplane shown in FIG. 3.

FIG. 4B shows a top view of the M2 layer of the backplane shown in FIG. 3.

FIG. 4C shows a top view of the M1 layer of the backplane shown in FIG. 3.

FIG. 5A shows a cross-sectional view of a second example shutter-based display apparatus 501 including a tiered backplane slot structure.

FIG. 5B shows a cross-sectional view of a third example shutter-based display apparatus 501 including a tiered backplane slot structure.

FIG. 6 is a flow chart of an example process of manufacturing a display apparatus.

FIG. 7 is graph showing the increase in light throughput achieved in a shutter-based display apparatus including one example of a tiered backplane slot structure.

FIGS. 8 and 9 show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be capable of displaying an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (for example, e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

The light output profile of a display apparatus with a backplane having multiple light blocking layers can be improved by varying the width of optical windows formed in the light blocking layers. Light can pass through a display apparatus at an angle. In some implementations, the angle can be based on the index of a refraction of a transparent material inside the display apparatus. For example, the angle can be about 46 degrees when the index of refraction is about 1.38, while the angle can be about 42 degrees when the index of refraction is about 1.5. If optical windows formed in the light blocking layers all have the same widths, then some of the light that passes through a lower layer will be blocked by an upper layer due to the angle of the light rays. The off-axis light throughput of the display is therefore diminished. To address this problem, the widths of optical windows formed in upper layers can be smaller than the widths of optical windows formed in lower layers. In some implementations, the difference in the widths of optical windows of adjacent layers can be substantially equal to the separation distance between the layers.

Particular implementations of the subject matter described in this disclosure can be implemented to realize one or more of the following potential advantages. In some types of displays, backplanes having stacked light blocking layers can be used. Optical windows can be formed in the stacked layers to permit light to exit the display. Increasing the widths of the apertures formed in higher layers can allow light from a wider range of angles to pass through the apertures, thereby increasing the viewing angle of the display. The increased light output can result in wider viewing angles and increased display brightness.

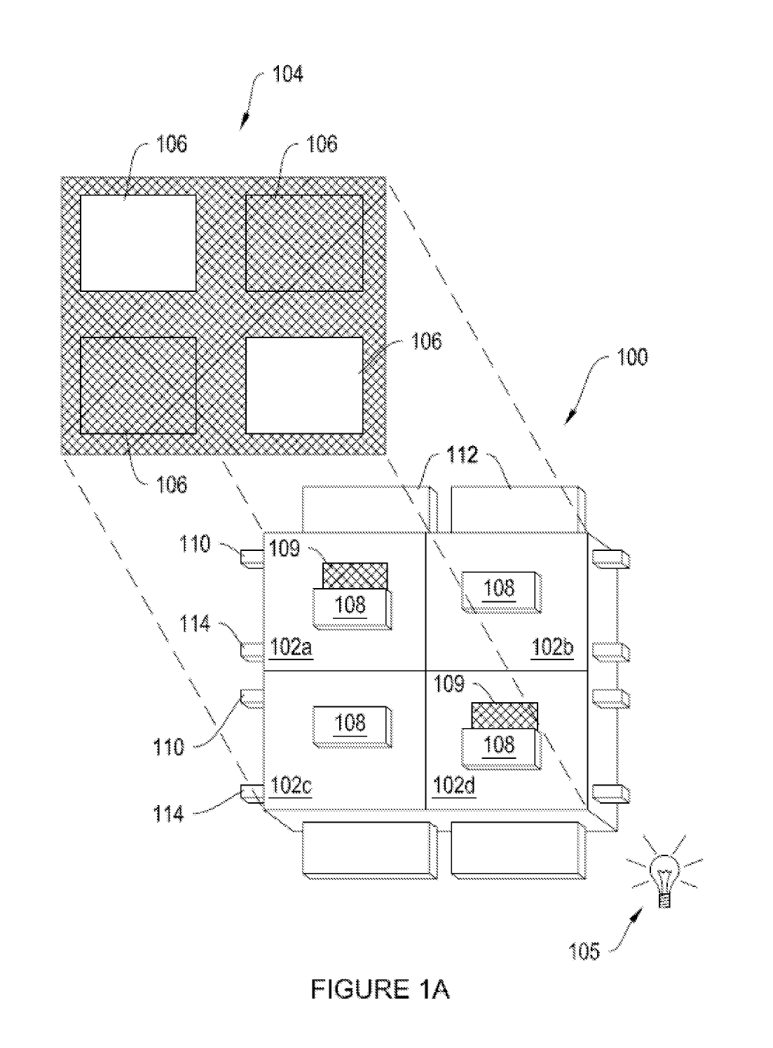

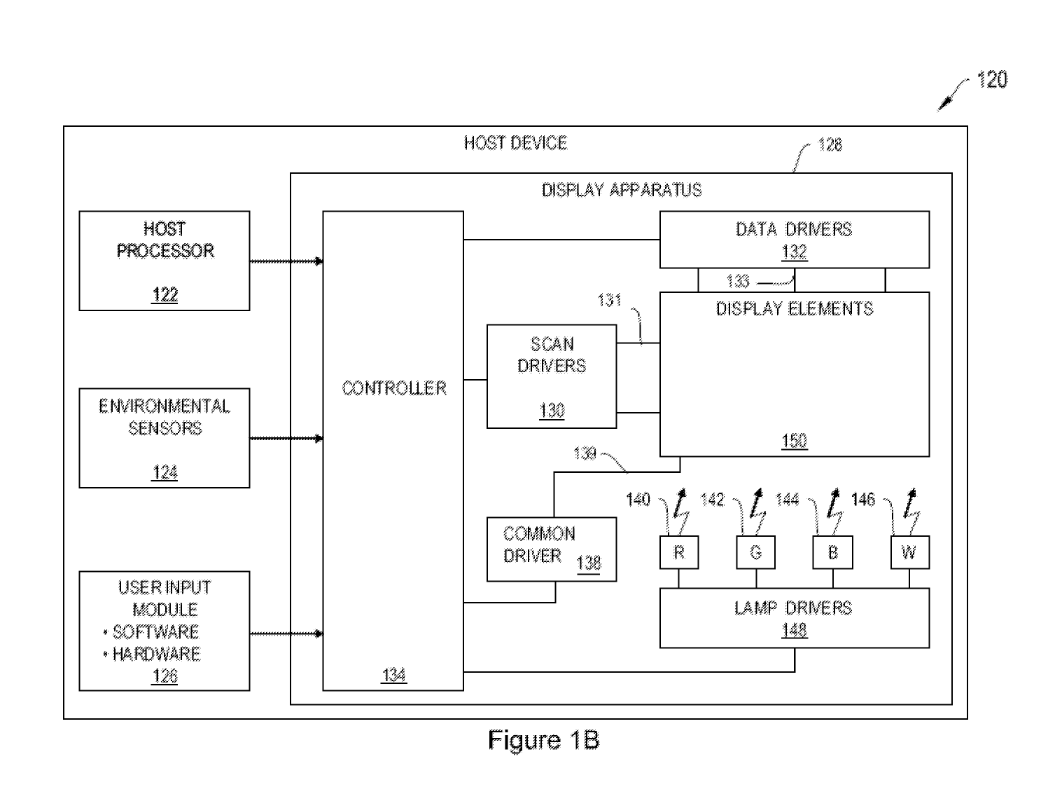

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent or glass substrates to facilitate a sandwich assembly arrangement where one substrate, containing the light modulators, is positioned over the backlight.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate actuation voltages, which are typically higher in magnitude than the data voltages, to the light modulators 102. The application of these actuation voltages results in the electrostatic driven movement of the shutters 108.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying only a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for only a certain fraction of the image is loaded to the array of display elements 150. For example, the sequence can be implemented to address only every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 conveys the personal preferences of the user to the controller 134, either directly, or via the host processor 122. In some implementations, the user input module 126 is controlled by software in which a user programs personal preferences, for example, color, contrast, power, brightness and content preferences. In some other implementations, these preferences are input to the host device 120 using hardware, such as a button, switch or dial, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

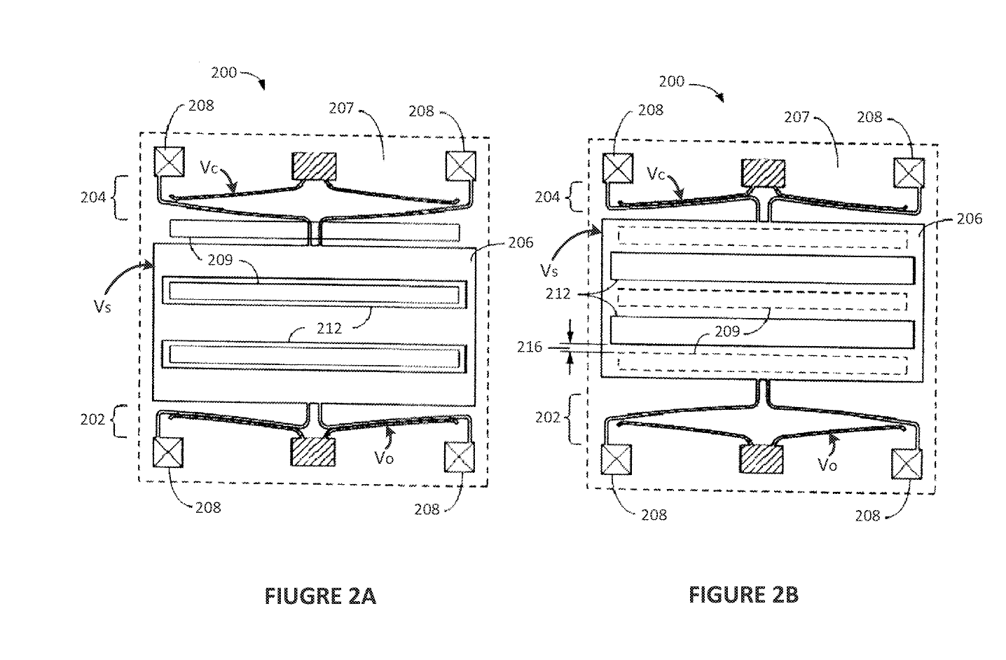

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have only a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after an actuation voltage is applied to the opposing actuator. The minimum voltage needed to maintain a shutter's position against such an opposing force is referred to as a maintenance voltage Vₘ.

Generally, electrical bi-stability in electrostatic actuators, such as actuators 202 and 204, arises from the fact that the electrostatic force across an actuator is a strong function of position as well as voltage. The beams of the actuators in the light modulator 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, such as the light modulator 200, the equilibrium position of the light modulator will be determined by the combined effect of the voltage differences across each of the actuators. In other words, the electrical potentials of the three terminals, namely, the shutter open drive beam, the shutter close drive beam, and the load beams, as well as modulator position, are considered to determine the equilibrium forces on the modulator.

For an electrically bi-stable system, a set of logic rules can describe the stable states and can be used to develop reliable addressing or digital control schemes for a given light modulator. Referring to the shutter-based light modulator 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed state, whichever position was established by the last actuation event.

If |Vₒ−Vₛ|>Vₐₜ and |V_{c}−Vₛ|<Vₘ (rule 3)

Then the shutter will move into the open position.

If |Vₒ−Vₛ|<Vₘ and |V_{c}−Vₛ|>Vₐₜ (rule 4)

Then the shutter will move into the closed position.

Following rule 1, with voltage differences on each actuator near zero, the shutter will relax. In many shutter assemblies, the mechanically relaxed position is only partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems an exceptional degree of bi-stability or hysteresis can be provided, with Vₘ existing over a range of about 2% and about 98% of Vₐₜ. In these systems, however, care must be taken to ensure that an electrode voltage condition of |V_{c}−Vₛ| or |Vₒ−Vₛ| being less than Vₘ can be reliably obtained within the addressing and actuation time available.

In some implementations, the first and second actuators of each light modulator are coupled to a latch or a drive circuit to ensure that the first and second states of the light modulator are the only two stable states that the light modulator can assume.

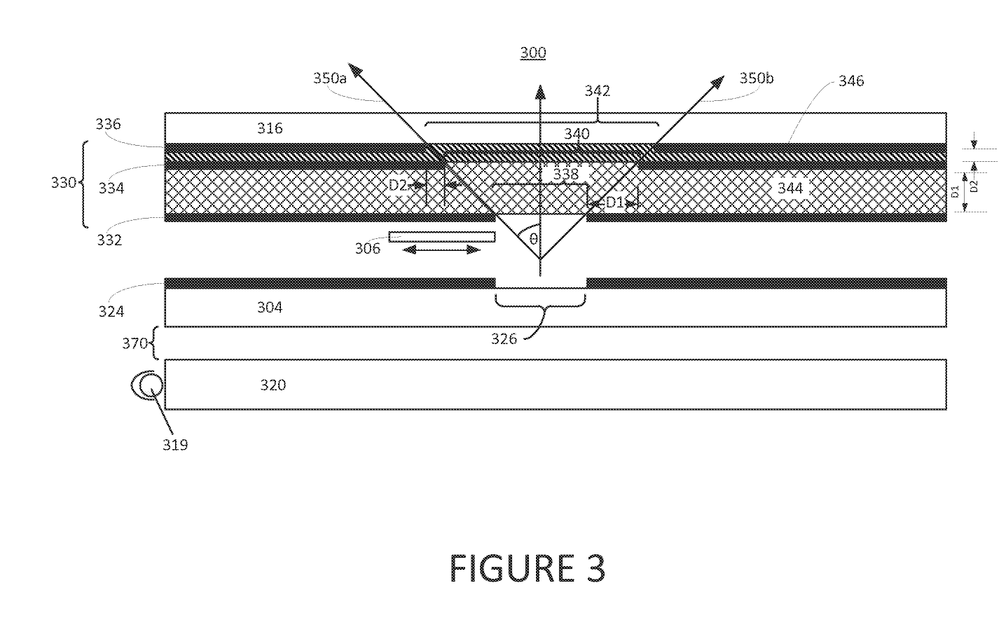

FIG. 3 shows a cross-sectional view of an example shutter-based display apparatus 300 including a tiered backplane slot structure. The display apparatus 300 includes a shutter 306 suspended between a front substrate 316 and a rear substrate 304. The shutter 306 is shown in an open position in FIG. 3. A rear aperture layer 324 is positioned on the front-facing surface of the rear substrate 304. The rear aperture layer 324 defines a rear aperture 326. A backplane 330 is positioned on the rear-facing side of the front substrate 316. The backplane 330 includes an M1 layer 336, an M2 layer 334, and an M3 layer 332. A lower dielectric layer 344 separates the M3 layer 332 from the M2 layer 334. An upper dielectric layer 346 separates the M2 layer 334 from the M1 layer 336. It should be understood that the upper dielectric layer 346 may include one or more layers, having different indices of refraction. Similarly, the lower dielectric layer 344 also may include one or more layers, having different indices of refraction.

The M3 layer 332, M2 layer 334, and M1 layer 336 of the backplane 330 define an inner optical window 338, a middle optical window 340, and an outer optical window 342, respectively. The optical windows 338, 340, and 342 are aligned with the rear aperture 326 to define an optical path through which light can escape from the shutter assembly 300 towards a viewer. A light source 319 and a light guide 320 (together forming a backlight) are positioned behind the rear substrate 304. The light guide 320 is separated from the rear substrate 304 by a gap 370. In some implementations, the gap 370 can be filled with air. In some other implementations, the gap 370 can be filled with another fluid or a vacuum. The fluid or vacuum filling the gap 370 can aid in extracting a desired angular distribution of light from the light guide 320.

In some implementations, the shutter 306 of the display apparatus 300 can function in a manner similar to the shutter 206 of the light modulator 200 shown in FIGS. 2A-2B. The shutter 306 can be moved laterally into open and closed positions, in response to actuation voltages. When the shutter 306 is in an open position, as shown in FIG. 3, the shutter 306 is positioned beside the optical path between the aperture 326 and the outer optical window 342, allowing light to pass through the display apparatus 300. Wider viewing angles are often desirable for electronic displays. To increase the viewing angle of a display device incorporating the display apparatus 300, the middle optical window 340 is wider than the inner optical window 338, and the outer optical window 342 is wider than the middle optical window 340.

FIG. 3 also shows two example light rays 350a and 350b (generally referred to as light rays 350) traveling out of the display apparatus 300. The light rays 350 form an angle with respect to a vertical direction. In some implementations, the angle of the light rays 350 is determined in part by the material filling the gap between the aperture layer 324 and the M3 layer 332 of the backplane 330. For example, in some implementations, this gap may be filled with an oil or other fluid having an index of refraction of about 1.38. Therefore, the angle of the maximum angle of light rays 350 may be about 46 degrees.

In some implementations, the amount of light output by the display apparatus 300 can be increased by designing the display apparatus 300 such that the middle optical window 340 is wider than the inner optical window 338, and the outer optical window 342 is wider than the middle optical window 340. The relative widths of the optical windows can be selected such that the light passing through the light modulator at the maximum possible angle (e.g., about 45 degrees) based on the dimensions of the display apparatus 300 and the index of refraction of the materials in the display apparatus 300 can exit the display apparatus 300 without being absorbed by or reflected off of the components of the backplane 330.

The M3 layer 332, the M2 layer 334, and the M1 layer 336 can each be formed from metals. In some implementations, the metals may be selected to be substantially non-reflective, so that light impinging on the surfaces of the M3 layer 332, the M2 layer 334, and the M1 layer 336 is absorbed and blocked rather than reflected. In other implementations, the M3 layer 332, M2 layer 334, and M1 layer 336 can be formed from another material, such as a light-absorbing resin.

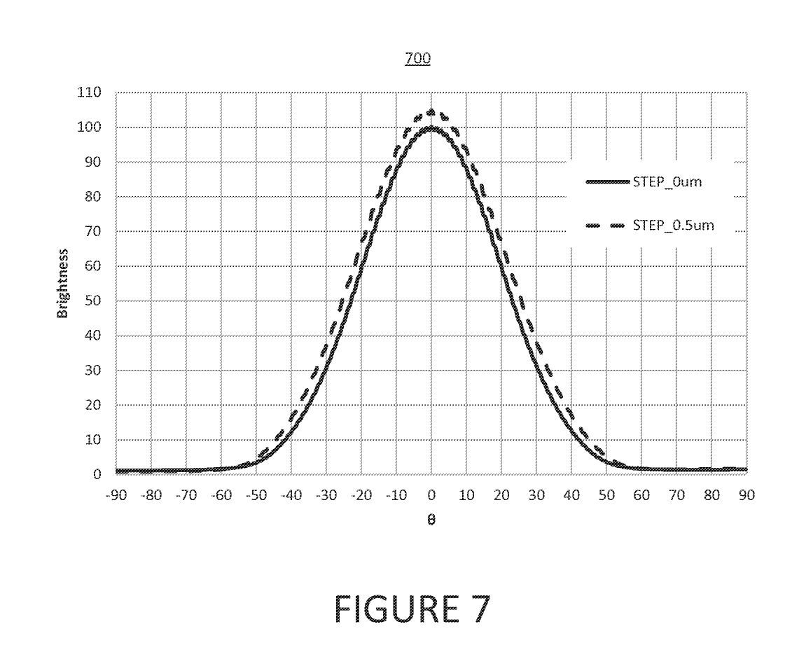

The M3 layer 332, the M2 layer 334, and the M1 layer 336 of the backplane 330 can be used, for example, to route data signals throughout a display device incorporating the display apparatus 300. For example, the backplane 330 can be used to control the position of the shutter 306 by transmitting control signals to actuators (not shown) configured to move the shutter 306 laterally within the display apparatus 300. In some implementations, such data signals may generate electric fields that interfere with proper operation of the shutter 306. In implementations in which the M3 layer 332, the M2 layer 334, and the M1 layer 336 are formed from metal, the parasitic capacitances that result from the adjacent metal layers can increase the electrical power required to transmit data signals through the display apparatus 300. Increasing the thickness of the lower dielectric layer 344 increases the separation distance D1 between the M3 layer 332 and the M2 layer 334 of the backplane 330, thereby decreasing their capacitance. Increasing this distance, however, without adjusting the widths of the optical windows 338, 340, and 342 can interfere with the transmission of off-axis light through the backplane 330. In some implementations, the M3 layer 332 can also be held at the same potential as the shutter 306 to prevent the shutter 306 from being drawn towards the M3 layer 332 of the backplane 330. A rather surprising result is that increasing the distance D1 without adjusting the widths of the optical windows 338, 340, and 342 can also interfere with the transmission of on-axis light through the backplane 330 due to diffraction effect, as discussed further below in connection with FIG. 7. In some implementations, if the width of the outer optical window 342 is increased substantially more than twice the distance D1, the benefit of the increase in transmission of on-axis light can be diminished, while the drawback of the reduction in ambient light contrast ratio can increase. For example, this may occur in implementations in which the M1 layer 336 is more light absorptive than the M2 layer 334 and the M3 layer 332.

The widths of the optical windows 338, 340, and 342 can be selected based on the thickness D1 of the lower dielectric layer 344 and the thickness D2 of the upper dielectric layer 346. For example, in some implementations, the optical window 340 formed in the M2 layer 334 of the backplane 330 can have a width equal to the width of the optical window 338 of the M3 layer 332 plus two times the thickness D1 of the lower dielectric layer 344. Therefore the right-hand edge of the optical window 340 formed in the M2 layer 334 is spaced a distance D1 in both the lateral and vertical directions away from the right-hand edge of the optical window 338 formed in the M3 layer 332, and the left-hand edge of the optical window 340 formed in M2 layer 334 also is spaced a distance equal to D1 in both the lateral and vertical directions away from the left-hand edge of the optical window 338 formed in the M3 layer 332. Such a configuration maintains an angle of about 45 degrees between the edges of the optical window 338 and the optical window 340 with respect to the vertical direction. While FIG. 3 illustrates the separation distances and widths of the optical windows 338 and 340 for a display in which the maximum angle of the light rays 350 is about 45 degrees, the display apparatus 300 may also be configured to maintain any desired angle between the edges of the optical window 338 and the optical window 340. For example, the relative increase in widths of the optical windows 338 and 340 can be approximately determined by 2*ΔD tan(sin⁻¹(1/n)), where ΔD is the distance between two optical windows 338 and 340, such as D1, and n is the index of refraction of the lower dielectric layer 344 between the two windows 338 and 340. Note that tan(sin⁻¹(1/n))≈1. Note that due to the variation in the fabrication process, the width of the optical window 340 formed in the M2 layer 334 of the backplane 330 may not be equal to exactly the width of the optical window 338 plus two times the distance D1. For example, in some implementations, the width of the optical window 340 can vary between the width of the optical window 338 of the M3 layer 332 plus two times the thickness D1 of the lower dielectric layer 344 times 0.8 and the width of the optical window 338 of the M3 layer 332 plus two times the thickness D1 of the lower dielectric layer 344 times 1.2. That is, the width of the optical window 340 can be in the range of about the width of the optical window 338 plus between 1.6*D1 to about the 2.4*D1.

Similarly, the right-hand edge of the optical window 342 formed in M1 layer 336 is spaced a distance equal to D2 in both the lateral and vertical directions away from the right-hand edge of the optical window 340 formed in the M2 layer 334, and the left-hand edge of the optical window 342 formed in M1 layer 336 also is spaced a distance equal to D2 in both the lateral and vertical directions away from the left-hand edge of the optical window 340 formed in the M2 layer 334. Such a configuration maintains an angle of about 45 degrees between the edges of the optical window 342 and the optical window 340 with respect to the vertical direction. In implementations in which the maximum angle of the light rays 350 is greater than or less than 45 degrees, for example due to different dimensions or indices of refraction, these spacing dimensions can be adjusted appropriately to ensure that the widths of the optical windows 338, 340, and 342 permit the light rays 350 to exit the display apparatus 300 at the maximum angle possible. In some other implementations, the width of the optical windows 338, 340, and 342 are maintained to allow a maximum light output level of 45 degrees, even though light rays at higher angles could escape the display apparatus, because further widening the optical windows 338, 340, and 342 can reduce the contrast ratio of the display apparatus 300 by allowing additional ambient light to reflect back to a user. In some implementations, the relationship between the separation distance D2 of the M1 layer 336 and the M2 layer 334, the widths of the optical windows 342 and 340, and the maximum angle of the light rays 350 may be determined as discussed above in connection with the optical windows 338 and 340. For example, the relative increase in widths of the optical windows 340 and 342 can be approximately determined by 2*ΔD tan(sin⁻¹(1/n)), where ΔD is the distance between two optical windows 340 and 342, such as D2, and n is the index of refraction of the upper dielectric layer 346 between the two windows 340 and 342.

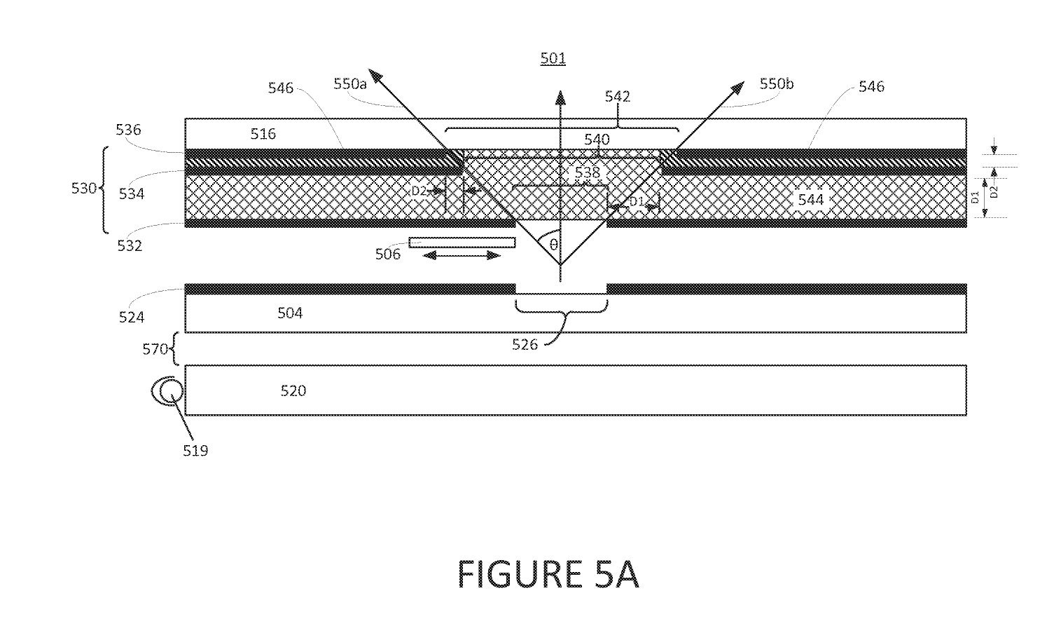

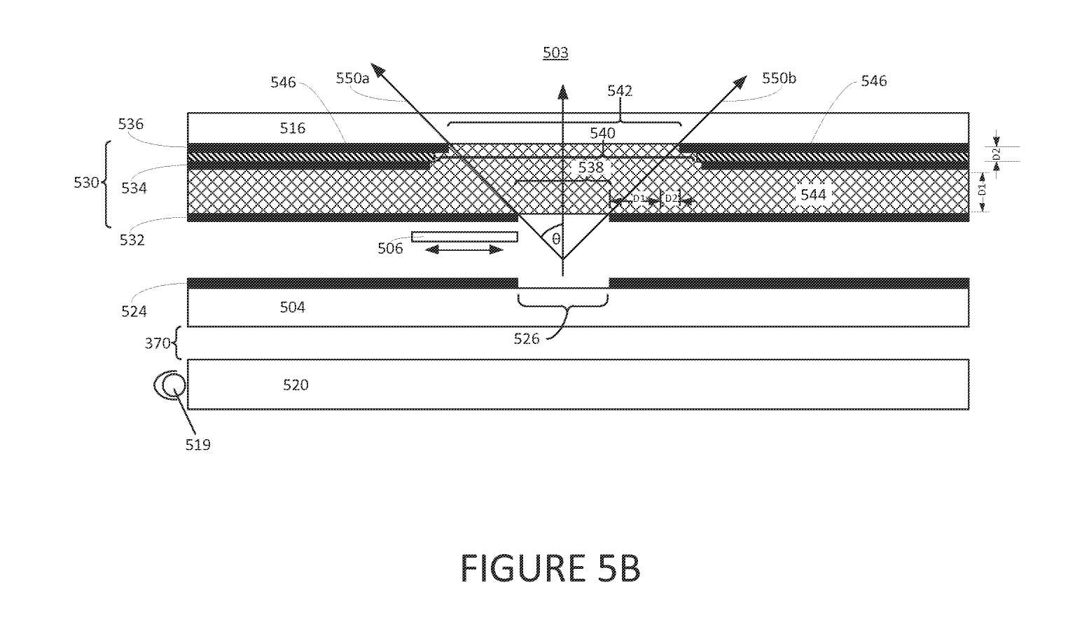

In some implementations, the interface between the upper dielectric layer 346 and the lower dielectric layer 344 may interfere with the light rays 350. For example, while both the upper dielectric layer 346 and the lower dielectric layer 344 may be formed from transparent materials, their surfaces may reflect a portion of the light incident upon them. In some implementations, the upper dielectric layer 346 includes a material that has a relatively high index of refraction (e.g., an index of refraction in the range of about 1.8-2.2), while the lower dielectric layer 344 has a relatively low index of refraction (e.g., an index of refraction in the range of about 1.5-1.6). Therefore, some of the light from the light rays 350 may be reflected as it passes through the interface between the upper dielectric layer 346 and the lower dielectric layer 344, resulting in a lower quality or reduced brightness image. This problem can be overcome by etching at least one of dielectric layers, as discussed further below in connection with FIGS. 5A-5B.

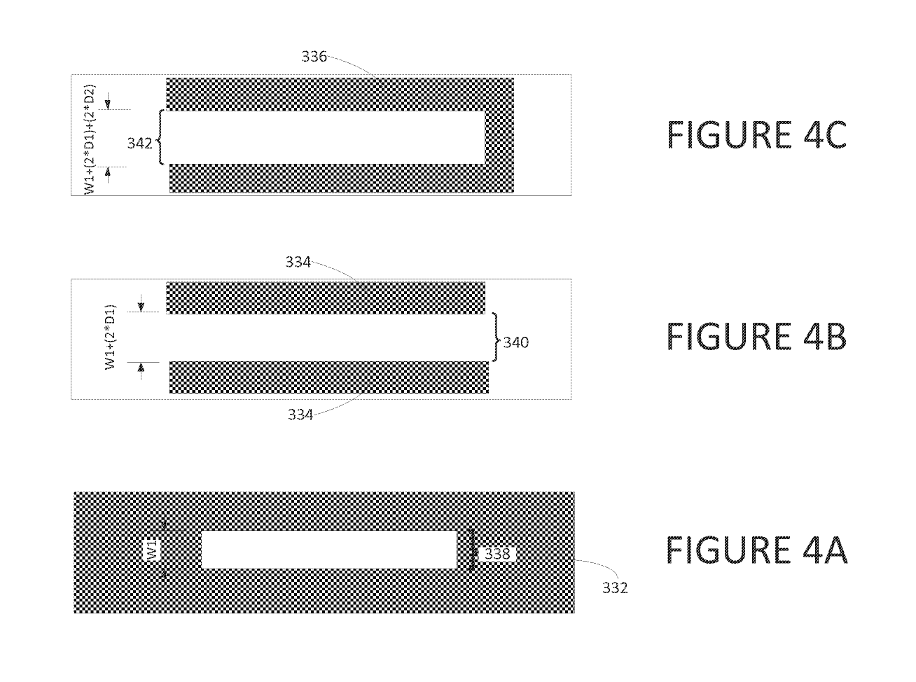

FIG. 4A shows a top view of the M3 layer 332 of the backplane 300 shown in FIG. 3. The cross-hatched portion represents the material forming the M3 layer 332, while the white portion represents the optical window 338. As shown, the optical window 338 is formed as an aperture in the M3 layer 332 having a width of W1. The optical window 338 is entirely surrounded by the light blocking material that forms the M3 layer 332.

As discussed above, in some implementations, the M3 layer 332 can be formed from a metal. The metal can be selected to have light blocking properties. In some implementations, the metal can also be selected to absorb light rather than to reflect light. By absorbing light, the M3 layer 332 can reduce the amount of ambient light or erroneously reflected light exiting the display apparatus 300. This can improve the performance of a display in which the display apparatus 300 is incorporated, for example by increasing the contrast ratio of the display. If a metal material is used to construct the M3 layer 332, the metal, if kept at a common potential as the shutter 306, can also serve to prevent attraction between the shutter 306 and the backplane 330. In other implementations, a non-metal material, such as a resin, may be used to form the M3 layer 332.

FIG. 4B shows a top view of the M2 layer 334 of the backplane 330 shown in FIG. 3. The M2 layer 334 includes two disconnected portions of light blocking material (shown as cross-hatched portions). The light blocking material may be a metal or a resin, as discussed above in connection with FIG. 4A. The optical window 340 is defined by the two portions of light blocking material forming the M2 layer 334 of the backplane. The optical window 340 has a width of W1 plus two times D1. W1 represents the width of the optical window 338 formed in the M3 layer 332, as shown in FIG. 4A. The width of the optical window 340 is larger than the width of the optical window 338 to allow light traveling at an angle to pass through both optical windows when the M2 layer 334 is positioned above the M3 layer 332 in a display apparatus. In some implementations, the maximum angle at which light can exit the light modulator is approximately 45 degrees. Therefore, the distance D1 can be selected to be equal to the separation distance between the M3 layer 332 and the M2 layer 334.

FIG. 4C shows a top view of the M1 layer 336 of the backplane 300 shown in FIG. 3. The optical window 340 is defined by the gap between two connected portions of light blocking material (shown as shaded portions in FIG. 4C) forming the M1 layer 336 of the backplane 330. The light blocking material may be a metal or a resin, as discussed above in connection with FIG. 4A. The optical window 342 has a width of W1 plus about two (e.g., between about 1.6 and about 2.4) times D1 plus about two (e.g., between about 1.6 and 2.4) times D2. W1 plus about two times D1 represents the width of the optical window 340 formed in the M2 layer 334, as shown in FIG. 4B. The width of the optical window 342 is larger than the width of the optical window 340 to allow light traveling at an angle to pass through both optical windows when the M1 layer 336 is positioned above the M2 layer 334 in a light modulator. In some implementations, the maximum angle at which light can exit the light modulator is approximately 45 degrees. Therefore, the distance D1 can be selected to be equal to the separation distance between the M3 layer 332 and the M2 layer 334, and the distance D2 can be selected to be equal to the separation distance between the M2 layer 334 and the M1 layer 336.

The layers 332, 334, and 336 of the backplane shown in FIGS. 4A-4C are merely illustrative, and other arrangements may be used. For example, in some implementations one or more of the M3 layer 332, the M2 layer 334, and the M1 layer 336 may include additional optical windows, which may be open at one or both ends or may be completely enclosed. In some implementations, all of the optical windows can have the same configuration (i.e., all open at one or both ends or all completely enclosed) or have any combination of the above configurations. In some implementations, the optical window 340 of the M2 layer 334 can have a width substantially greater than the width of the optical window 342 formed in the M1 layer 336, as discussed further below in connection with FIG. 5B.

FIG. 5A shows a cross-sectional view of a second example shutter-based display apparatus 501 including a tiered backplane slot structure. The display apparatus 501 includes many of the components of the display apparatus 300 shown in FIG. 3. For example, the display apparatus 501 includes a shutter 506 suspended between a front substrate 516 and a rear substrate 504. A rear aperture layer 524 is positioned on the front-facing surface of the rear substrate 504. The rear aperture layer 524 defines a rear aperture 526. A backplane 530 is positioned on the rear-facing side of the front substrate 516. The backplane 530 includes an M3 layer 532, an M2 layer 534, and an M1 layer 536. A lower dielectric layer 544 separates the M3 layer 532 from the M2 layer 534. An upper dielectric layer 546 separates the M2 layer 534 from the M1 layer 536. The M3 layer 532, M2 layer 534, and M1 layer 536 of the backplane 530 define an inner optical window 538, a middle optical window 540, and an outer optical window 542, respectively.

The upper dielectric layer 546 has been substantially etched away from the optical path through which light exits the display apparatus 501 when the shutter 506 is in the open position. It should be understood that part of the upper dielectric layer 546 having a relatively low index of refraction (e.g., an index of refraction in the range of about 1.45-1.6) may be unetched or only partially etched. The resulting gap is filled in by the lower dielectric layer 544. As shown in FIG. 5A, the edges of the upper dielectric layer 546 that result from the etching process are positioned in the path of the light rays 550. In some implementations, this may cause light scattering as the light rays 550 reflect off of a surface of the upper dielectric layer 546. For example, while the upper dielectric 546 can be transparent, a portion of the light rays 550 may still be scattered by the etched surface of the upper dielectric layer 546, which could impact the quality of an image formed on a display in which the display apparatus 501 is incorporated. Etching the upper dielectric layer 546 back farther from the edge of the optical window 542 can eliminate this potential problem, as discussed below.

FIG. 5B shows a cross-sectional view of a third example shutter-based display apparatus 503 including a tiered backplane slot structure. The shutter-based display apparatus 503 includes all of the components of the shutter-based display apparatus 501 shown in FIG. 5A and the shutter-based display apparatus 300 shown in FIG. 3. As in the display apparatus 501, the upper dielectric layer 546 in the display apparatus 503 is etched back from the area defining the optical path through which light exits the display apparatus 503. In this implementation, the M2 layer 534 of the backplane 530, as well as the upper dielectric layer 546, are etched back from the edge of the optical window 542 formed in the M1 layer 536. Therefore, the optical window 540 formed in the M2 layer 534 is wider than the optical window 542 formed in the M1 layer 536.

As shown, the light rays 550 can pass through the display apparatus 503 unobstructed, because the proper angle is maintained between edges of the optical windows in the M3 layer 532 and the M1 layer 536. Furthermore, because the upper dielectric layer 546 is etched to form an opening wider than the optical window 542, the light rays 550 do not contact a surface of the upper dielectric layer 546 as they would in the display apparatus 501 shown in FIG. 5A. In some implementations, the distances by which the width of the optical window 540 exceeds the width of the optical window 542 may be chosen to be relatively small. For example, the presence of the M2 layer 534 of the backplane 530 helps to reduce the amount of stray light that exits the display apparatus 503. Designing the optical window 540 to be only slightly larger than the optical window 542 can lead to the improved optical properties that result from moving the surface of the upper dielectric layer 546 out of the path of the light rays 550 while still blocking a large percentage of stray light that might otherwise erroneously exit the display apparatus 503.

Similarly, designing the optical window 542 of the upper layer 536 to be only slightly wider than is necessary to accommodate the maximum possible angle of the light rays 550 can help to achieve the goals of increasing light emission from the display apparatus 503 and limiting the ambient light reflected from the front of the display apparatus 503. For example, when the optical window 542 is made wider, more ambient light from the environment in which the display apparatus 503 is used will be permitted to enter the display apparatus 503. The interior surfaces of the display apparatus 503 may be partially reflective, causing some of the ambient light to reflect out of the display apparatus 503. As a result, the contrast ratio of a display in which the display apparatus 503 is incorporated can be decreased. Therefore, designing the optical window 542 of the upper layer 536 to be only slightly wider to accommodate the maximum possible (or desired) angle of the light rays 550, as is shown in FIG. 5B, can allow the upper layer 536 to block ambient light while permitting high light emission from the light guide 520 when the shutter 506 is in an open position.

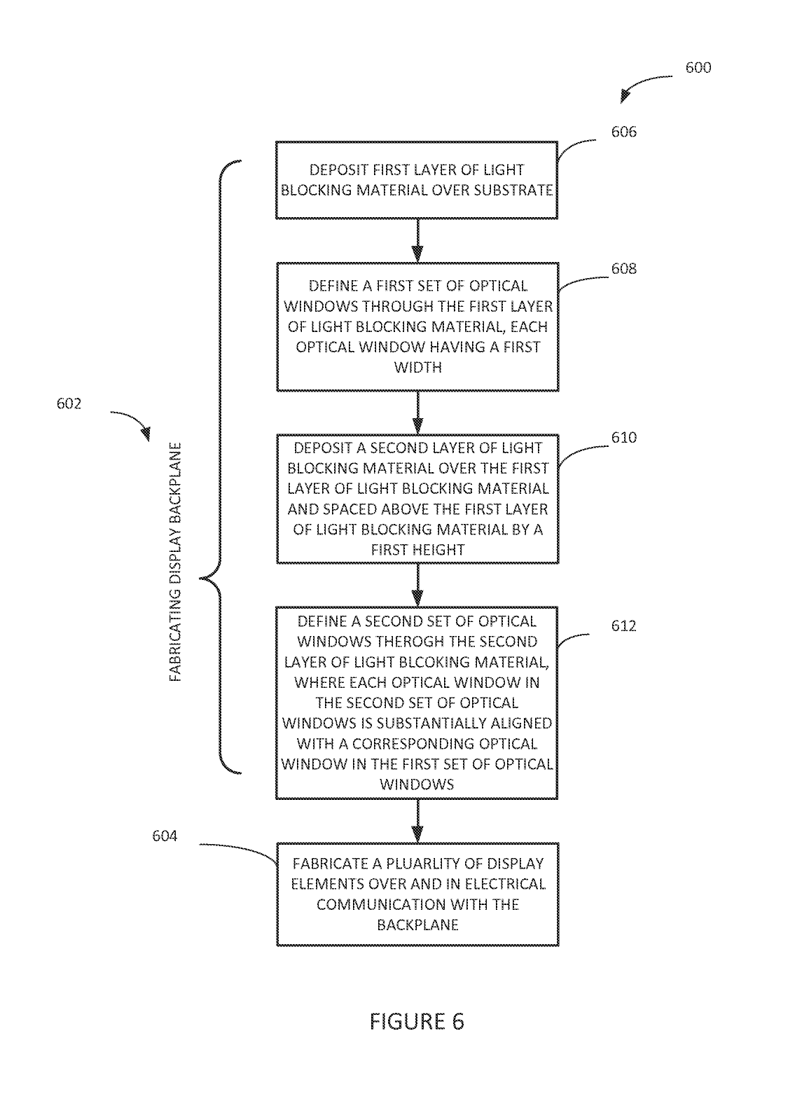

FIG. 6 is a flow chart of an example process of manufacturing a display apparatus 600. The process includes two phases, fabricating a display backplane (phase 602) and fabricating a plurality of display elements over and in electrical communication with the backplane (phase 604). The display backplane fabrication phase (phase 602) includes depositing a first layer of light blocking material over a substrate (stage 606), and defining a first set of optical windows through the first layer of light blocking material (stage 608). Each optical window in the first set of optical windows has a first width. The backplane fabrication phase (phase 602) further includes depositing a second layer of light blocking material over the first layer of light blocking material and spaced above the first layer of light blocking material by a first height (stage 610) and defining a second set of optical windows through the second layer of light blocking material such that each optical window in the second set of optical windows is substantially aligned with a corresponding optical window in the first set of optical windows and has a second width, smaller than the first width (stage 612).

As indicated above, fabricating the display backplane includes depositing a first layer of light blocking material over a substrate (stage 606). In some implementations, the substrate is formed from glass, plastic, or some other transparent material. The first layer of light blocking material can be a metal or other light blocking material, such as a resin in which light absorbing particles are suspended. For example, the first layer of light blocking material can be the material forming the M1 layer 336 or the M2 layer 334 of the display backplane 330 shown in FIG. 3. If the first layer of blocking material is a metal, the layer can be deposited using a thin film deposition process, such as DC or RF sputtering, evaporation, or in some cases by chemical or physical vapor deposition. If the first layer of light blocking material is a light blocking resin, the first layer can be deposited using spin-on techniques.

A first set of optical windows are defined through the first layer of light blocking material such that each optical window in the first set has a first width (stage 608). The first set of optical windows, can correspond, for example, to optical windows formed in the M1 layer 336 or M2 layer 334, such as the outer optical window 342 or the middle optical window 340, shown in FIG. 3. The first width can range from about 10 μm to about 25 μm. If the first layer of light blocking material is a metal, the optical windows can be defined using typical etching techniques, including RF or DC plasma etching, sputter etching, reactive ion milling, and/or wet chemical etching. At the same time the optical windows are etched, various electrical interconnects and components that make up the display backplane can be defined into the first layer of light absorbing material. Optical windows in resin based layers of light blocking material may be defined through direct photolithography and development, or through one or more of the etch techniques described above.

A second layer of light blocking material is deposited over the first layer of light blocking material (stage 610). The second layer of light blocking material spaced above the first layer of light blocking material by a first height. The first height can correspond, for example, to the thickness of one or more intervening dielectric layers that separate the first and second layers of light blocking material. The dielectric material is substantially transparent and can correspond, for example to the lower dielectric layer 344 or the upper dielectric layer 346 of the display backplane 330 shown in FIG. 3. In some implementations, the first height corresponds to the combined thicknesses of multiple dielectric layers as well as one or more additional intervening light blocking layers. For example, in some implementations, the first layer of light blocking material corresponds to the M1 layer 336 shown in FIG. 3, and the second layer of light blocking material corresponds to the M3 layer 332 of the display backplane 330. In such implementations, the first height could correspond to the combined thicknesses of the lower dielectric material 344, the M2 layer 334, and the upper dielectric material 346. The first height can range from about 0.3 μm to about 3.5 μm. As with the first layer of light blocking material, the second layer of light blocking material may be a metal, a light absorbing resin, or other light blocking material, such as cermet.

A second of optical windows is defined through the second layer of light blocking material (stage 612). Each optical window in the second set of optical windows is substantially aligned with a corresponding optical window in the first set of optical windows and has a second width, smaller than the first width. The optical windows in the second set of optical windows can be defined as described above with respect to the definition of the optical windows in the first layer of light blocking material. In some implementations, the second set of optical windows can correspond to the optical windows formed in the M2 or M3 layers of the display backplane 330 shown in FIG. 3, such as the middle optical window 340 or the inner optical window 338. In some implementations, the width of the optical windows in the second set of optical windows is smaller than the width of the optical windows in the first set of optical windows by about twice the first height. In some implementations, the width of the optical windows in the first set of optical windows is greater than the width of the optical windows in the second set of optical windows by between 1.6 and 2.4 times the first height. In some implementations, at the same times the optical windows are defined, and as part of the same process, additional interconnects and/or other electrical components of the backplane can be defined into the second layer of light blocking material.

In the second phase, a plurality of display elements are fabricated over, and in electrical communication with, the backplane (phase 604). The display elements can include, for example EMS-based, such as MEMS or nanoelectromechanical systems (NEMS) based display elements. In some implementations, the display elements are MEMS shutter based light modulators, such as the shutter based light modulator 200 shown in FIGS. 2A and 2B.

The fabrication of the display elements (phase 604) can include the formation of a mold over which a shutter assembly is formed, a structural material deposition stage, followed by a patterning stage, and a release stage. To form the mold, a first sacrificial material is deposited and patterned to form vias or openings in which a portion of the an anchor can be formed. The openings are formed over contact pads patterned into the uppermost layer of the backplane. A second sacrificial material is deposited on top of the patterned first layer of sacrificial material. The second layer of sacrificial material is patterned to form a mold, which includes substantially vertical sidewalls and a top surface. The mold also includes vias or openings that align with the vias and openings formed in the first sacrificial layer. The fabrication of the display element further includes deposition and patterning of a structural material that will form the shutter and the anchor. The structural material can include one or more layers of material, such as a metal and/or a semiconductor. The structural material is deposited over the sidewalls and the top surface of the mold, and also in the openings or vias to form electrical connections with the backplane via the contact pads. The deposited structural material is then patterned, typically, using anisotropic etching. The patterning is carried out in a manner such that the structural material remains on the sidewalls of the mold to form actuator beams, on the upper surface of the mold to form a shutter, and in the openings of the mold to form the anchor. While the above discusses one example process for forming a display element, a person having ordinary skill in the art will readily understand that a display element could be formed using other fabrication techniques.

FIG. 7 is graph 700 showing the increase in light throughput achieved in a shutter-based display apparatus including one example of a tiered backplane slot structure. The data shown in the graph 700 is based on a simulation conducted with display apparatus similar to the display apparatus 300 shown in FIG. 3. For example, the display apparatus used to generate the graph 700 includes an M3 layer defining an inner optical window and an M2 layer defining a middle optical window separated by a lower dielectric layer having a width of 12 microns. The inner optical window and the middle optical window have substantially identical widths. The display apparatus also includes an M1 layer defining an outer optical window. The M1 layer is separated from the M2 layer by an upper dielectric layer having a width of 2 microns. The graph 700 shows a solid line representing the light throughput achieved in a display apparatus in which the outer optical window has the same width as the middle optical window. The graph 700 also shows a broken line representing the light throughput achieved in a display apparatus in which the edges of the outer optical window are spaced 0.5 microns back from the edges of the middle optical window (i.e., the outer optical window has a width 1 micron greater than the width of the middle optical window).

The graph 700 shows that light throughput is increased over a wide range of angles in the display apparatus having a tiered backplane slot structure. As discussed above in connection with FIG. 3, the light throughput for such a display apparatus is not only increased for off-axis light, but for on-axis light (i.e., light transmitted at an angle of zero degrees) as well. For example, the on-axis light throughput is increased by about 5% in the display apparatus including the tiered backplane slot structure, as shown by the broken line in FIG. 7.

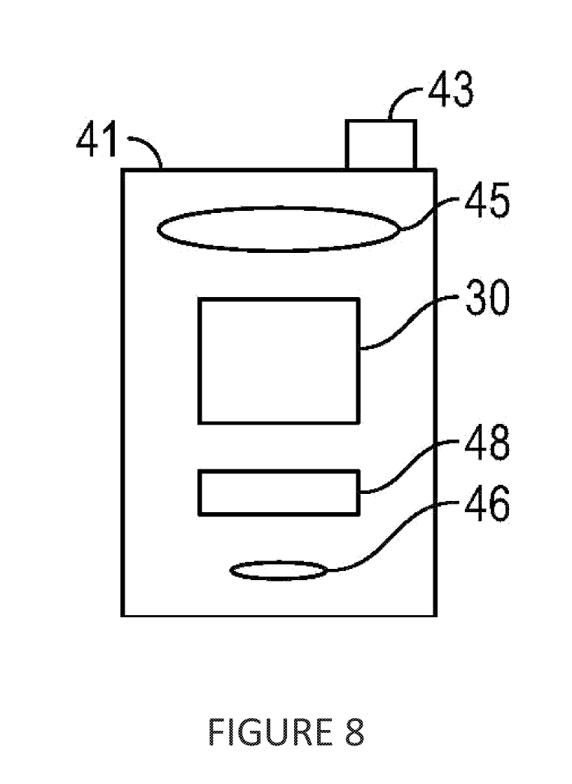

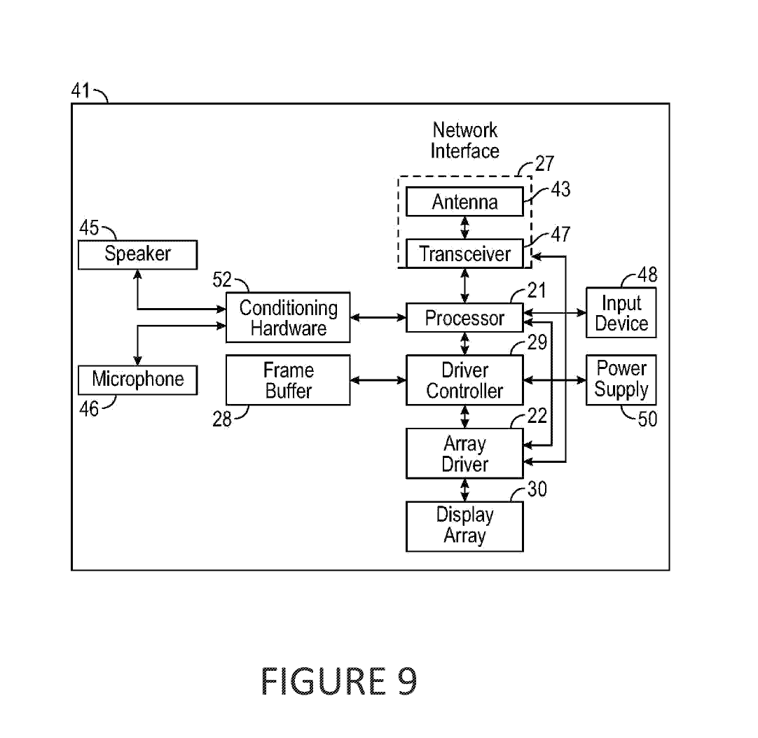

FIGS. 8 and 9 show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display. The display 30 also can include a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIGS. 8 and 9, can be capable of functioning as a memory device and communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of acting as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a substrate; and
a display element including:
a backplane suspended over the substrate, the backplane including:
a first light-blocking layer oriented parallel to the substrate and defining a first optical window having a first width; and
a second light blocking layer oriented parallel to the substrate and spaced above the first light-blocking layer by a first height, the second light blocking layer defining a second optical window having a second width, greater than the first width.

2. The apparatus of claim 1, wherein the second width is in the range of about the first width plus between 1.6 and 2.4 times the first height.

3. The apparatus of claim 2, wherein the backplane further comprises a first dielectric layer positioned between the first light-blocking layer and the second light-blocking layer.

4. The apparatus of claim 1, wherein the backplane further comprises a third light-blocking layer oriented parallel to the substrate and spaced above the second light-blocking layer by a second height, the third light blocking layer defining a third optical window having a third width, greater than the second width.

5. The apparatus of claim 4, wherein the third width is in the range of about the second width plus between about 1.6 and about 2.4 times the second height.

6. The apparatus of claim 1, further comprising a transparent fluid filling the space between the substrate and the backplane.

7. The apparatus of claim 6, wherein the relationship between the first width and the second width is based in part on the first height and an index of refraction of the transparent fluid.

8. The apparatus of claim 4, wherein the third light-blocking layer has a lower reflectivity than the first light-blocking layer and the second light-blocking layer.

9. The apparatus of claim 4, wherein the backplane further comprises a second dielectric layer positioned between the second light-blocking layer and the third light-blocking layer, and the second dielectric layer includes a material having a higher index of refraction than the first dielectric layer.

10. The apparatus of claim 9, wherein the second dielectric layer is etched away in the third optical window.

11. The apparatus of claim 1, wherein the display element includes a microelectromechanical systems (MEMS) shutter-based light modulator.

12. The apparatus of claim 1, further comprising:
a display;
a processor that is capable of communicating with the display, the processor being capable of processing image data; and
a memory device that is capable of communicating with the processor.

13. The apparatus of claim 12, further comprising:
a driver circuit capable of sending at least one signal to the display; and wherein the processor is further capable of sending at least a portion of the image data to the driver circuit.

14. The apparatus of claim 12, further comprising:
an image source module capable of sending the image data to the processor, wherein the image source module includes at least one of a receiver, transceiver, and transmitter.

15. The apparatus of claim 12, further comprising:
an input device capable of receiving input data and to communicate the input data to the processor.

16. A method of manufacturing a display apparatus, comprising:
fabricating a display backplane by:
depositing a first layer of light blocking material over a substrate;
defining a first set of optical windows through the first layer of light blocking material, each optical window having a first width;
depositing a second layer of light blocking material over the first layer of light blocking material and spaced above the first layer of light blocking material by a first height;
defining a second set of optical windows through the second layer of light blocking material, wherein each optical window in the second set of optical windows is substantially aligned with a corresponding optical window in the first set of optical windows and has a second width, smaller than the first width; and
fabricating a plurality of display elements over and in electrical communication with the backplane.

17. The method of claim 16, wherein the first width is in the range of about the second width plus 1.6 times the first height to about the second width plus 2.4 times the first height.

18. The method of claim 16, further comprising:
depositing a third layer of light blocking material over the second layer of light blocking material and spaced above the second layer of light blocking layer by a second height;
defining a third set of optical windows through the third layer of light blocking material, each optical window in the third set of optical windows substantially aligned with respective optical windows in the first and second sets of optical windows and having a third width smaller than the first and second widths.

19. The method of claim 18, wherein the second width is in the range of about the third width plus 1.6 times the second height to about the third width plus 2.4 times the second height.

20. The method of claim 18, further comprising:
depositing a first dielectric layer over the first layer of light blocking material prior to depositing the second layer of light blocking material;
depositing a second dielectric layer over the second layer of light blocking material prior to depositing the third layer of light blocking material, wherein the second dielectric layer includes a material having a higher index of refraction than that of the material in the first dielectric layer.
